(19) United States
(12) Patent Application Publication
(10) Pub. No.: US 2004/0189026 A1
(43) Pub. Date: Sep. 30, 2004

(54) Pet refuse collection and carrying device and system

(76) Inventors: Steven W. Denham, Aurora, CO (US); Penny H. Denham, Aurora, CO (US); Kyle Aaron, Idledale, CO (US)

Correspondence Address: TIMOTHY J MARTIN, PC, 9250 W 5TH AVENUE, SUITE 200, LAKEWOOD, CO, 80226, US

(21) Appl. No.: 10/760,710

(22) Filed: Jan. 20, 2004

Related U.S. Application Data
(60) Provisional application No. 60/441,142, filed on Jan. 17, 2003.
(60) Provisional application No. 60/488,691, filed on Jul. 18, 2003.

(51) Int. Cl. A01K 29/00; E01H 1/12

(52) U.S. Cl. 294/1.3

(57) ABSTRACT

A pet refuse collection device includes a container body having an interior formed by a base and a surrounding sidewall. A movable lid encloses the interior. A scoop member is secured to either the container body or the lid so that, when the lid is closed, the scoop member is enclosed in the interior of the container body. A handle may be provided on the container body. In one embodiment, the scoop member is formed as an extension of the container body, for example, as a tongue-like extension, and in another embodiment the scoop member is a spoon-like member having its handle secured to the lid. The lid may be pivotally attached to the container body and may be spring biased to an open position. A latch can be used to retain the lid in the closed position.

### FIELD OF THE INVENTION

The present invention broadly concerns devices that may be used to gather trash, debris, and other refuse from the surface. More particularly, the present invention concerns the manual collection of pet excrement from surfaces, such as lawns, sidewalks and the like. The present invention specifically concerns a pet refuse collection device and system which may be secured to a person's clothing and carried during ambulatory exercises yet which may be detached to scoop and bag the pet refuse in a sanitary manner.

### BACKGROUND OF THE INVENTION

Many human activities produce waste of a wide variety, and the management of waste through collection and disposal has increasingly become a concern of many cultures. Not only is the disposal of waste generated by humans a concern to the environment, but also the collection and removal of animal refuse, particularly excrement generated by pets, is a concern not only for aesthetic reasons, but also for hygienic reasons. For example, dogs and cats are commonly kept as domestic companions for many persons. Fecal material deposited by the pet creates an unsanitary condition and detracts from the aesthetics of the environment. Removal of an animal's fecal material is therefore necessary.

While many pets, such as cats, have designated toilet areas in the home, it is common practice to allow a pet to roam in the outdoor environment, such as the yard area surrounding the home. In addition, many pets, such as dogs, are often walked in public and semi-private areas and sometimes have access even to private yards. These pets often defecate during such activities. As a result of the widespread population of pets, many communities have enacted regulations requiring pet owners to collect fecal material from their animals when the animals are taken on walks in order to ensure that unsanitary fecal material is removed from the public areas. Fortunately, more and more pet owners are recognizing their responsibility in the collection and disposal of pet refuse both from the public areas as well as from private areas, including their own private spaces.

Many people find the collection of animal excrement to be unpleasant and, if undertaken improperly, such collection can be unhealthy. Accordingly, many people resort either to protective gloves or other hand protection while collecting fecal material. Alternatively, some people use implements to accomplish the task. Such items include a variety of scoops, dustpans or other implements. The problem is further compounded when more than one hand is needed to collect the waste. Oftentimes the animal is on a leash requiring that the owner use one hand for restraining their pet leaving only the other hand free to collect the refuse.

Not only is the collection of the animal refuse unpleasant and potentially unsanitary, it is usually unacceptable for the excrement to be deposited directly into a refuse container. In order to dispose of the excrement in a manner as safe as possible, it is often desirable to contain the excrement in a relatively well-sealed bag or other container prior to disposal in a trashcan, for example. In many cases, this can lead to additional unwanted handling of the pet refuse which only serves to increase the unpleasantness of the task.

There have been several collection devices developed for the scooping of pet refuse for disposal. One such device is shown in U.S. Pat. No. 5,868,447 issued Feb. 9, 1999 to Clark et al. In this device, a working head, in the form of a scoop like structure, is secured to an elongated handle. The working head included an upstream intake portion and a downstream discharge portion so that excrement may be scooping in at the front of the working head and discharged at the rear. The working head supports a bag that allows refuse being discharged therefrom to be collected in a flexible bag for disposal.

Other collection devices include scoops with elongated handles. For example, U.S. Pat. No. 3,688,483 issued Sep. 5, 1972 to Hamilton discloses a garden tool wherein a rake like device supports a bag for collection of refuse. U.S. Pat. No. 4,986,587 also discloses an elongated handle that supports a scoop with a collection bag. U.S. Pat. No. 4,447,082 shows a scoop that supports a collection bag with this scoop being secured to an elongated handle. U.S. Pat. No. 4,149,745 issued Apr. 17, 1979 to Willis discloses a hollow scoop shaped device that also supports a collection bag.

Despite the development of the above noted devices, there remains a need for a compact portable scoop for pet refuse that may be carried by a person during ambulatory activities with a minimum of inconvenience. There is also a need for such collection devices that are compact in nature. There is further a need for pet collection refuse devices that maximize the ease of collection and the sanitary disposal of such pet refuse and require only a single hand to operate.

### SUMMARY OF THE INVENTION

It is an object of the present invention to provide a new and useful device for the collecting and carrying refuse, particularly pet excrement.

It is another object of the present invention to provide a highly portable and compact refuse collection device that includes a sanitary bagging system.

A further object of the present invention is to provide a collection device for pet excrement which decreases the unpleasantness associated with refuse collection.

Still a further object of the present invention is to provide a collection device for pet excrement which requires only a single hand to collect the excrement.

Yet another object of the present invention is to provide a pet collection device that is inexpensive to manufacture and which is easy to use.

According to the present invention, then, a pet refuse collection device and system is adapted to be used by a person to retrieve and store pet refuse for subsequent disposal. Broadly, the pet refuse collection device includes a container body having an open interior that includes a base portion in the surrounding sidewall portion extending from the base. The sidewall portion has an upper rim defining an opening into the interior of the container body. A lid member is adapted to be moved between an open position to permit access to the interior of the container body through the opening and a closed position wherein the lid encloses the interior. A scoop member is provided that is secured to one of the container body and the lid member. The scoop member is oriented such that, when the lid member is moved into the closed position, the scoop member is enclosed by the container body and the lid member. The pet refuse collection system, then, uses this pet refuse collection device and includes a flexible bag that lines the interior of the container with the bag having a mouth portion releasably secured proximately to the rim of the sidewall.

In one embodiment, the scoop member secured to the container body at a location proximate to the opening. This scoop member may be formed as a tongue-like extension of the sidewall at the rim thereof. In another embodiment, the scoop member includes an elongated shaft secured at a first end to the lid and that has a scoop portion located at the second end opposite the lid. When the scoop member is secured to the container body, the lid may be pivotally secured to the body and configured, for example, as a domelike shell, that fits over the scoop member when in the closed position. The container body and the lid, in this configuration, are formed such they are egg-shaped when the lid is in the closed position.

A handle may be provided and may be secured to the container body. The handle may be formed integrally with the container body, and the base of the container body may be flattened so that the container body may be set in a stable manner on a flat support surface. Alternatively, when the scoop member is secured to the lid, the handle may be secured also to the lid on the side thereof opposite the shaft. In this embodiment, the handle may be also pivotally secured to the lid. Also, if desired, a clip element may be secured to the container body. This clip element is adapted to mount the container body to an article of clothing to be worn by a person in order to facilitate transport of the pet refuse collection device.

The pet refuse collection device is adapted to receive a bag and retain the bag in the interior. To this end, the container body can have an exterior channel formed therein with the channel extending at least partially around the container body proximate to the rim. This channel is adapted to engage the mouth portion of a flexible bag inserted into the interior of the container body. In one embodiment, an upstanding flange is located proximately to the rim and is provided with a notch formed therein. This notch is adapted to engage a gathered portion of the mouth of the flexible bag which is inserted into the interior of the container body. In another embodiment, a collar is releasably securable to the container in order to trap the mouth of the flexible bag in the channel. Where the scoop member is a tongue like extension of the sidewall, a pair of flanges may extend from the rim on either side of the scoop member. Here, the channel is formed of the scoop member and flanges.

As noted, the lid may be spring biased into the open position. In such case, a latch may be provided with the latch moveable between an engaged state when it retains the lid in the closed position and a disengaged state where it permits the lid to move into the open position. This latch, if desired, may be biased into the engaged state. The latch may also include a ramp portion, and the lid is then configured to include a mounting arm that terminates in an edge positioned to engage the ramp portion of the latch when the lid moves from the open position to the closed position thereby to move the latch from the engaged state to the disengaged state.

The pet refuse collection device may also be provided with a compartment in order to store extra bags for the placement in the interior of the container. Here, the container body includes a compartment formed separate from the interior, and the extra bags may be placed in this compartment.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view showing a person in an ambulatory state carrying the pet refuse collection device according to a first exemplary embodiment of the present invention;

FIG. 2 is a side view in elevation showing the pet refuse collection device according to the first exemplary embodiment of the present invention stably supported on a flat support surface;

FIG. 3 is a perspective view of the pet refuse collection device of FIG. 2;

FIG. 4 is a side view in cross-section showing the pet refuse collection device of FIGS. 2 and 3 with the lid member being in the open position;

FIG. 5 is a side view in cross-section similar to FIG. 4, but showing the lid member in a closed position and with a bag member according to the pet refuse collection system shown in phantom;

FIG. 6 is a top plan view of the pet refuse collection device of FIGS. 2 and 3 shown with the lid in the open position;

FIG. 7 is a top plan view, similar to FIG. 6, but showing a bag mounted therein according to the pet refuse collection system of the present invention;

FIG. 8 is an enlarged side view in cross-section showing the latch used to release the lid member into the open position and to retain the lid in closed position;

FIG. 9 is a perspective view of a pet refuse collection device according to a second embodiment of the present invention shown with its lid in the open position and with a collection bag therein to define a collection system;

FIG. 10 is a side view in elevation of the pet refuse collection device of FIG. 9 with the lid in the open position;

FIG. 11 is a side view in elevation of the pet refuse collection device of FIG. 9 with the lid in the closed position;

FIG. 12 is a rear view in elevation of pet refuse collection device of FIG. 9 with the lid in the open position;

FIG. 13 is a sectional view taken about lines 13-13 of FIG. 12;

FIG. 14 is a perspective view of the collar used in the second exemplary embodiment of the present invention;

FIG. 15 is a side, elevation view of the collar used in the second exemplary embodiment of the present invention;

FIG. 16 is a perspective view of the container body used in the second exemplary embodiment of the present invention;

FIG. 17 is a side, elevation view of the container body used in the second exemplary embodiment of the present invention;

FIG. 18 is a perspective view of the zarf used in the second exemplary embodiment of the present invention with an exploded view of the pin and spring used therewith;

FIG. 19 is a perspective view of the lid used in the second exemplary embodiment of the present invention, and

FIG. 20 is a side, elevation view of the lid used in the second exemplary embodiment of the present invention.

FIG. 21 is a cross sectional view, similar to FIG. 13, of a pet refuse collection device according to the third exemplary embodiment of the present invention;

FIG. 22 is a sectional view of the pet collection device according to the third exemplary embodiment taken about lines 22-22 of FIG. 21;

FIG. 23 is an exploded side view in elevation of a pet refuse collection device according to a fourth exemplary embodiment of the present invention;

FIG. 24 is a side view in cross-section of the container body of the collection device of FIG. 23 with a collection bag therein;

FIG. 25 is bottom perspective view of the lower portion of the container of FIG. 24 illustrating the auxiliary bag compartment thereof;

FIG. 26 is a side view in elevation of the scoop portion of the collection device of FIG. 23 shown with a scoop protecting bag secured thereto;

FIG. 27 is an enlarged perspective view of the scoop protecting bag retaining structure used on the scoop of FIG. 26;

FIG. 28 is a perspective view of a lower portion of a representative scoop according to the fourth exemplary embodiment of the present invention;

FIG. 29 is an enlarged side view in cross-section showing the collar securing the container to the container body without any collection bag and without the scoop portion being secured to the container according to the fourth exemplary embodiment of the present invention;

FIG. 30 is a cross-sectional view, similar to FIG. 29, but showing a collection bag secured by the collar as well as the attachment of the scoop portion to the container; and

FIG. 31 is a perspective view of an alternative embodiment of the scoop portion showing an alternative bag securing structure as well as a pivoting handle used in the fourth exemplary embodiment of the present invention.

### DETAILED DESCRIPTION OF THE EXEMPLARY EMBODIMENTS

The present invention broadly relates to refuse collection devices and systems, but more particularly concerns a collection device or system for the manual collection of animal excrement such as that generated by a pet during an ambulatory activity or otherwise. The invention is particularly directed to a highly portable collection device and system which may be worn by a person yet which may be removed for use and reattached to the person in a sanitary manner. The invention is also directed to a collection device and system which allows a single-hand operation.

According to the present invention, the collection device includes a container with a lid and handle and may include an optional collection bag. The lid is mounted such that it maybe moved between closed and open positions with respect to the container. When in the open position, the edge of the lid is removed from the container thus exposing the opening of the container body. When in the closed position, the lid seals the opening of the container body.

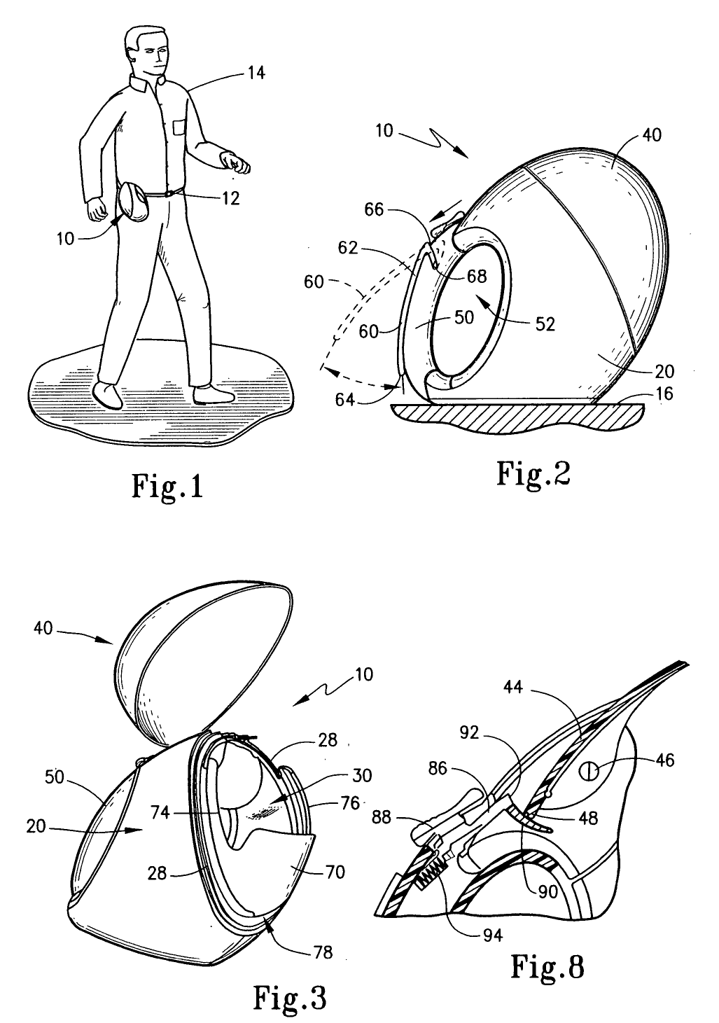

With reference to FIG. 1, then, it may be seen that a first exemplary embodiment of the pet refuse collection device 10 is shown attached to a belt 12 worn by a person 14 during an ambulatory activity. Although this figure illustrates collection device 10 being secured to belt 12, it should be understood that collection device 10 could be constructed to attach, as desired, to a person's clothing or otherwise be carried by the person. For example, the collection device 10 could simply be carried by its handle portion or, alternatively, it could be provided with mounting straps or the like so that it could be strapped, as desired, to the body of the user.

Pet refuse collection device 10 is best shown in FIGS. 2-8. In these figures, it may be seen that collection device 10 includes a container body 20 and a lid member 40 which, as more thoroughly described below, is pivotally secured to container body 20. Container body 20 has an open interior 22 that is defined by a flattened base portion 24 and a surrounding sidewall portion 26 that terminates in an upper rim 28 that defines an opening 30 into the interior 22 of container body 20. A medial portion of sidewall 26 has a step profile 27 formed therein. This creates an external shoulder 29 as well as a plurality of internal arcuate steps 31. Base portion 24 is flattened so as to permit the container body 20, and thus collection device 10, to be set in a stable manner on a flat support surface, such as flat support surface 16 shown in FIG. 2. Container body 20 may be molded as two matable sections such as sections 21 and 23, as is known in the art.

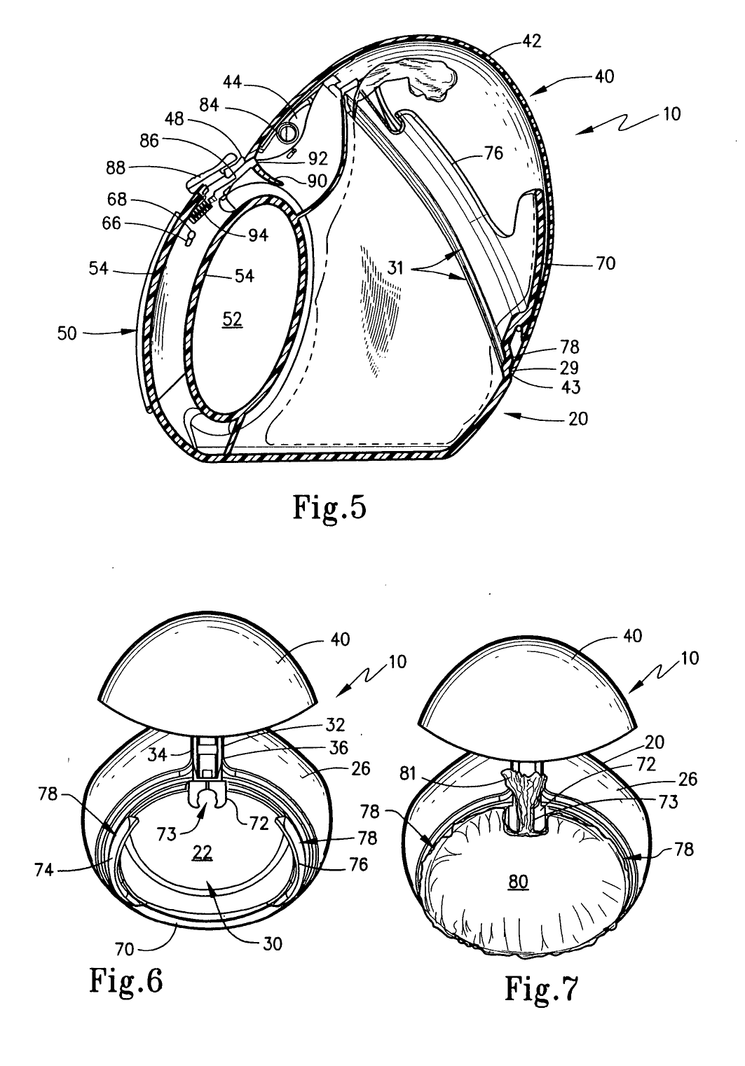

As noted above, lid member 40 is pivotally secured to container body 20. To this end, container body 20 has a bay 32 formed therein so as to have bay sidewalls 34 and 36 that are generally in parallel, spaced apart relation to one another. Lid 40 then has a cap portion 42 formed as a dome-shaped arcuate shell that has an outer end edge 43, and lid 40 has a mounting arm 44 that projects outwardly from cap portion 42. Mounting arm 44 is pivotally journaled on an axle pin 46 so that lid member 40 may be moved from a closed position (shown in FIGS. 2 and 5) to an open position (shown in FIGS. 3,4,6 and 7). Mounting arm 44 terminates in a free edge 48 that interacts with a ratch, as more thoroughly explained below. When its in the open position the lid member permits access to the interior of container body 20 that when in the closed position the lid 40 encloses the interior. Also, when in the closed position, edge 43 abuts shoulder 29, as is shown in FIG. 5, to create a substantial seal against leakage and odor,

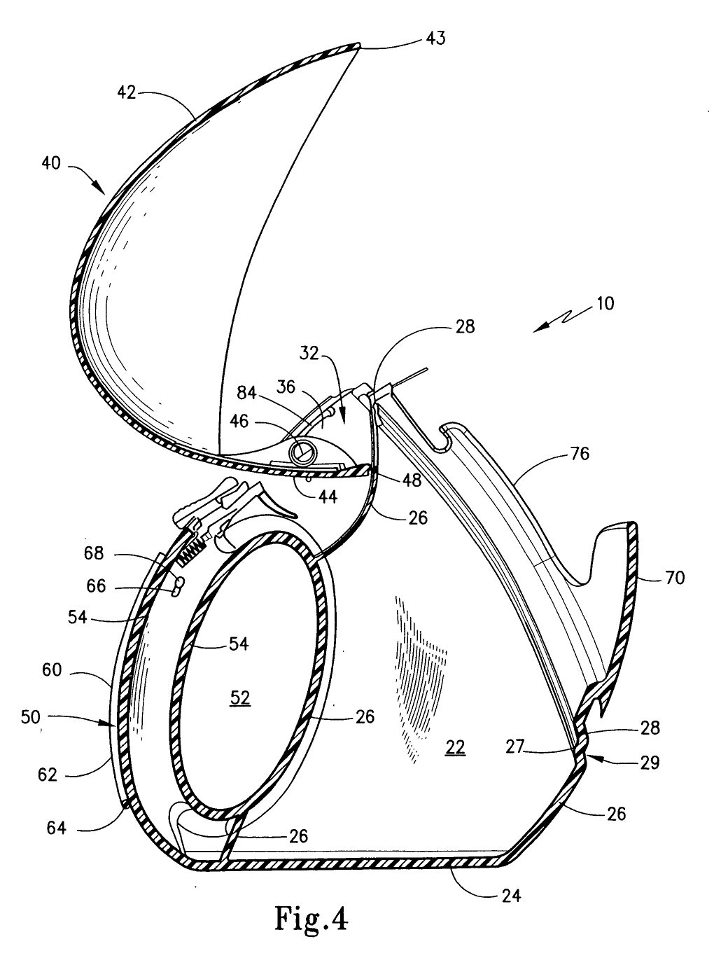

Container body 20 and lid member 40 are ovoid in shape so that collection device 10 is generally egg-shaped in configuration. Moreover, collection device 10 may include a handle portion which, in this embodiment, includes handle portion 50 that is secured to container body 20. Handle portion 50 may be formed integrally with container body 20 so as to define a hand-hold opening 52 for pet refuse collection device 10. As seen in FIGS. 4 and 5, handle 52 may be hollow and generally circular in cross-section. To this end, it is formed by handle sidewall 54 with handle at opening 52 then being located between handle 50 and sidewall 26 of container body 20.

A clip element may also be provided for pet refuse collection device 10. Here, clip element 60 is best illustrated in FIG. 2. Clip element 60 is a U-shaped wire piece that includes legs, such as legs 62 that are joined by a cross-piece 64 and terminate, at opposite ends, in angled feet 66 that may be received in holes 68 formed in handle 50. Clip element 60 normally rests alongside handle 50 but can be pivoted away from handle 50, as is shown in phantom in FIG. 2, so that it may be used to clip pet refuse collection device 10 to the belt or other article of clothing of a person, such as shown in FIG. 1.

Pet refuse collection device 10 also includes a scoop member that is secured, in this embodiment, to container body 20. With reference to FIGS. 3-6, it may be seen that scoop member 70 is formed as a tongue-like extension of sidewall portion 26 at a portion of rim 28 opposite handle 60. Thus, scoop member 70 is secured to container body 20 at a location proximate to opening 30. A pair of flanges 72 and 74 also extend from rim 28 on either side of scoop member 70 with flanges 74 and 76 along with scoop member 70 having an exterior channel 78 formed therein. Channel 78 is located exteriorly of container body 20 and extends at least partially around container body 20 proximate to rim 28. Channel 78 is adapted to engage a mouth portion of a flexible bag inserted into the interior of the container body 10. Thus, for example, with reference to FIG. 7, it may be seen that a flexible bag 80 may be inserted into the interior of container body 20 with a mouth portion thereof received in channel 78 and held tautly in position by means of an upstanding flange 72 that has a notch 73 that is sized and adapted to engage a gathered portion 81 of the mouth of flexible bag 80.

As noted above, lid 40 is spring biased into the open position. To this end, a spring element 84 extends around axle pin 46 and has its ends acting on bearing arm 44 and on a bay sidewall, such as bay sidewall 36. Also, as noted, a latch is provided with this latch being best illustrated in FIGS. 4, 5 and 8. Here, the latch includes a latch piece 86 that is slidably disposed in bay 32 with latch piece 86 including a thumb button 88 and a ramp portion 90. Latch piece 86 is moveable between an engaged state shown in FIG. 5, wherein a leading edge 92 interlocks with free edge 48 of arm member 44 to retain lid 40 in a closed position against the force of spring element 84.

Latch piece 86 is biased into the engaged state by means of a coil spring 94. However, latch piece 86 can be moved to a disengaged state, such as shown in FIG. 8, against the force of coil spring 94 so that leading edge 92 becomes disengaged from free edge 48 of mounting arm 40 thus allowing spring 84 to pivot lid 40 into the open position. When lid portion 40 is moved from the open position to the closed position, free edge 48 of mounting arm 44 acts against ramp portion 90 to again compress spring 94 so that lid portion 40 may be moved into the completely closed position. At this point, the restored force of spring 94 returns latch piece 86 to the position shown in FIG. 5 thereby retaining lid 40 in the closed position. Thus, when in the disengaged state, the latch permits the lid to move into the open position, under the biasing force of spring 84. Spring 94, accordingly, biases latch piece 86 into the engaged state.

Accordingly, it should be appreciated that pet refuse collection device 10 provides a safe and sanitary means of collecting and storing pet refuse for disposal. To this end, the pet refuse collection system of the present invention includes not only the collection device 10 but also at least one flexible bag, such as bag 80, that lines the interior of the container 10 with this bag 80 having a mouth portion 82 adapted to be releasably secured proximately to the rim of the sidewall of container 10.

In use, a person depresses latch piece 96 to move it into the disengage position. Lid 40 automatically springs open to allow access to interior 22 of container body 20. The user may then employ scoop member 70 that is protected by bag 80 to retrieve pet refuse. To this end, internal steps 31 help resist unwanted spillage of the refuse and help retain the refuse in the interior 22. The person next manually moves lid 40 to the closed position so that free edge 48 acts on ramp portion 90 thereby moving latch piece 86 to the disengage position until edge 48 reaches the location shown in FIG. 5, at which point latch piece 86 automatically is restore to the engage position due to spring 94. This retains lid 40 in the closed position with edge 43 in the sealed relationship with shoulder 29.

Further, it should be understood from the foregoing that container body 20, lid 40, handle 50, scoop member 70 and latch piece 86 can be constructed of any suitable material. It is contemplated by this invention that these pieces are to be made out of injection-molded plastic. However, other construction materials and techniques may be used as understood in these arts, without departing from the scope of the invention.

A second exemplary embodiment of a pet refuse collection device according to the present invention is shown in perspective in FIG. 2. Here it can be seen that this exemplary embodiment of collection device 110 includes a collection bag 116, a lid 118, a container body 120, a zarf 122 and a collar 124. The collar includes one or more belt clips 126, which can be clipped to a belt 12 or any similar type of strap (as demonstrated in FIG. 1). The belt clip may also contain one or more holes 134 to which a strap or lanyard can be attached. The exemplary embodiment discussed herein includes two belt clips 126, positioned on opposing sides of the collection device.

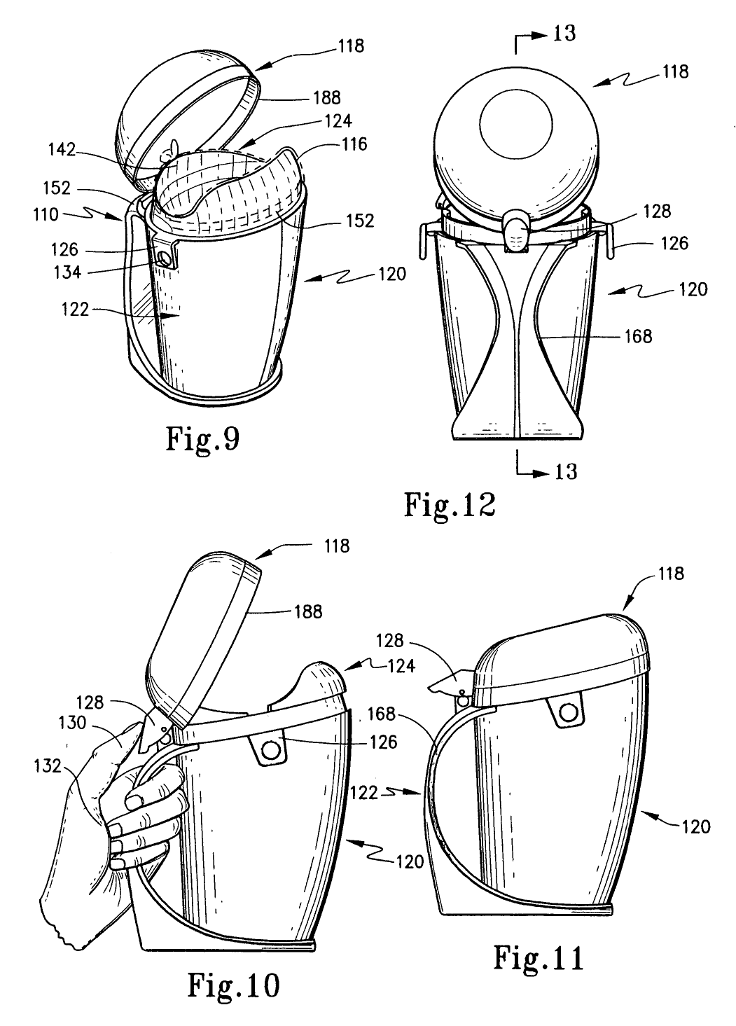

FIG. 9 shows the collection device 110 in the open position with a collection bag 116 therein. FIGS. 10 and 11 show the collection device in the open and closed position (respectively) and illustrate the position of the lid 118 with respect to the collar 124 and the container body 120 in these two states. As will be discussed later in detail, the lid 118 is maintained in the closed position by a resilient spring or other such mechanism. A thumb detent 128, affixed to the lid 118, is operative by a thumb 130 of a hand 132 to open the collection device 110.

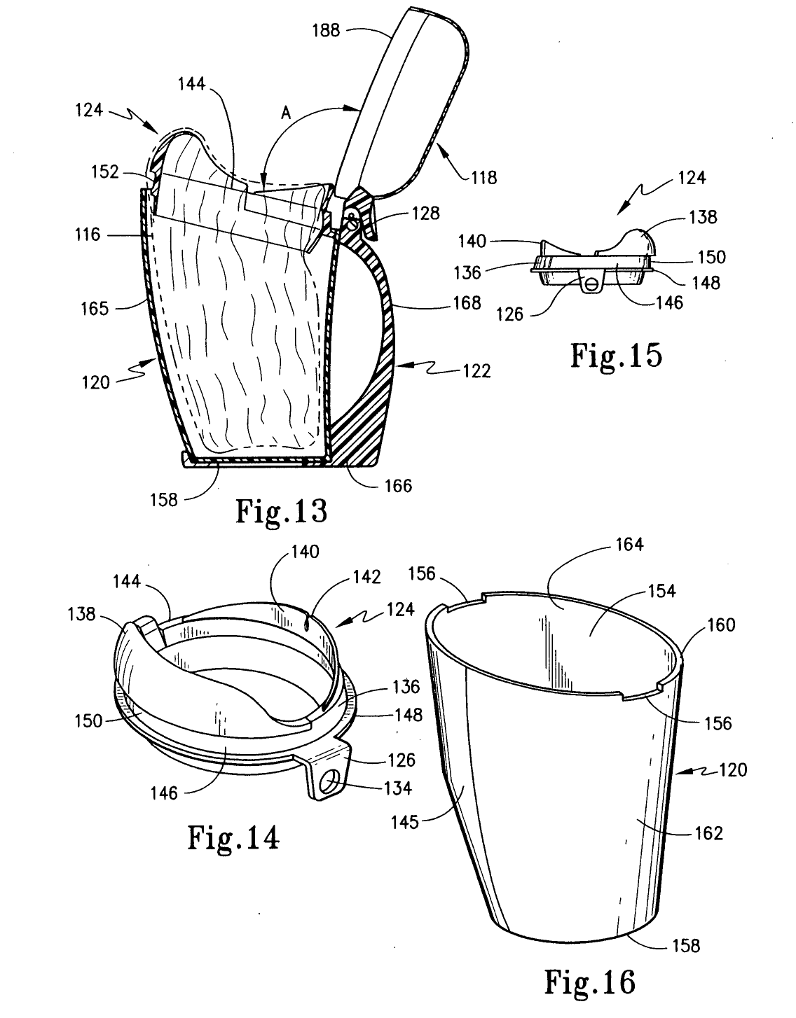

While the collection device 110 may be used without a collection bag 116, it may be preferred to place a disposable collection bag 116 within the device 110 to keep it free of waste matter and to ease cleaning. The collection bag 116 can be of a standard plastic bag type with a bag mouth edge 152 (see FIG. 9) and with a size sufficient to fit within the container body 120 and to fit over and around the collar 124. To best see this, refer to FIGS. 9 and 13. FIG. 9 shows a perspective of the collection device 110 in the open position with a collection bag therein. FIG. 6 shows a sectional view of the same. The collection bag 116 is positioned to reside within the collection body 120 and to be held in this position by its mounting onto the collar 124.

To best describe how the collection bag 116 is retained within the collection device 110, reference is made to the various views of the collar insert 124 in FIGS. 14 and 15. The collar insert 124 is an annular ring 136, with an upper edge 144, an outer surface 146, and an annular flange 148, a tongue 138, a flange 140, and one or more belt clips 126 disposed on the annular flange 148. The flange 140 is a partially-circular and tapered element, mounted onto the upper edge 144, which has a bag notch 142 formed within it and through which a portion of the bag mouth edge 152 can be secured. FIG. 9 shows a collection bag 116 secured within the bag notch 142. The tongue 138 is an arcuate and partially circular-shaped extension of the collar insert 124, mounted on the upper edge 144, and is contoured for a scoop-shape to facilitate the scooping or collection of waste material from a surface. The tongue 138 protrudes outwardly and beyond the outer surface 146 of the annular ring 136 to form a bag groove 150.

Again referring to FIGS. 9 and 13 it can be seen that the collection bag 116 is positioned such that the bag mouth edge 152 resides within the exterior channel defined by bag groove 150 and encompasses the outer surface 146 of the collar insert 124. In this manner the collection bag 116 covers the tongue 138 and the flange 140 and resides within the container body 120. The collection bag 116 is secured in this position by engaging the portion of the bag 116 nearest the bag notch 142 into the notch 142.

Referring to FIG. 13, when in the open position the lid edge 188 of lid 118 defines an angle A with respect to the plane of upper edge 144 of collar insert 124. Although angle A may be any acute angle, the collection of waste material is easier when the angle A is 90 degrees or greater.

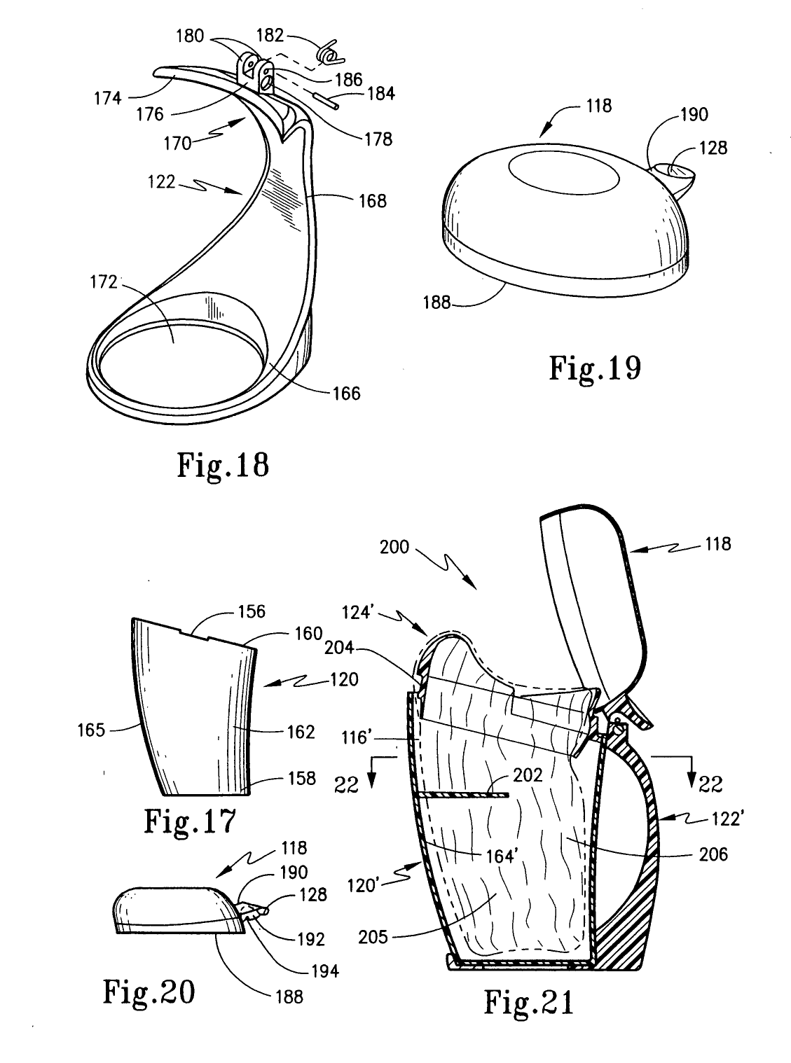

FIGS. 16 and 17 shows the container body 120 removed from the collection device 110. The container body 120 is of a tapered and curved cylindrical shape with a container base 158 at its distal end, an outer surface 162, an inner surface 164, and an opening 154. The proximal end of the cylindrical body 120 terminates in a rim 160. Located within the rim 160 are one or more notches 156 which are sized and positioned to allow the belt clips 126 to extend outwardly from the outer surface 162 when the collar insert 124 is mounted onto the container body 120. As seen in FIGS. 13, 16 and 17, the outer surface 162 of container 120 includes a convexly-shaped frontal surface 165 which is an arcuately curved surface shaped to facilitate the scooping of the waste from a surface.

To further describe the mounting of the collar insert 124 onto the container body 120, reference is made to FIGS. 13,14 and 15. The annular flange 148 of the collar insert 124 is an annular structure disposed onto the outer surface 146 and is sized such that it has a close-fitting engagement with the inner surface 164 of the container body 120 nearest the rim 160. The belt clips 126 are formed as L-shaped tabs which extend outwardly and downwardly from the annular flange 148 and are sized to provide space for mounting onto a belt 12 when the collar insert 124 is affixed to the container body 120. As previously described, the notches 156 in the rim 160 are sized such that they receive the belt clips 126 to further secure the collar insert 124 to the container body 120. The collar insert 124 may be affixed to the container body 120 by a number of joining means including ultrasonic welding, adhesives, snap-fit mechanisms or other techniques currently known in the art.

The zarf 122 is shown in FIGS. 9-11,13, and 18. The zarf 122 is of a curved and tapered shape that includes a base receiver portion 166, a handle portion 168, and a lid support structure 170. The base receiver portion 166, located at the distal end of the zarf 122, is a hoop-shaped portion of the zarf 122 and includes a base cavity 172 within which the base 158 of the container body 120 is seated, as is best seen in FIGS. 9-11. The lid support structure 170 at the proximal end of zarf 122 is connected to the base receiver portion 166 at the distal end by a handle portion 168. The handle portion 168 is a curved and tapered portion which is sized and positioned sufficiently far from the container body 120 to be grasped and held by a hand 132, as best demonstrated in FIG. 10.

Still referring to FIG. 18, the lid support structure 170 includes a curved free end 174 and a clevis 176. The curved free end 174 is an end surface with a curvature chosen to closely fit against the outer surface 162 of the container body 120 proximal to the rim 160. This is best seen in FIGS. 10-13. The clevis 176 includes a mount hole 178 through which a strap or lanyard may be placed to provide another means of carrying the collection device 110. The clevis 176 includes a pair of spaced-apart arms 180 in opposed relation to one another with a spring 182 disposed between them. Each arm 180 includes a pin hole 186 which receives a pin 184. The pin 184 retains the spring 182 between the arms 180.

The lid 118 is a domed-shaped structure with a lid edge 188 and includes a pivot portion 190, as can be seen in FIGS. 13, 19 and 20. The lid 118 and lid edge 188 are sized such that the lid 118 encloses the lip 138, flange 140, and the outer surface 146 of the collar 124 when the lid 118 is in the closed position. This is best seen in FIG. 11. The lid edge 188 is also sized to mate flush with the rim 160 of container body 120 when closed. Returning back to FIGS. 13, 19 and 20, a pivot portion 190 is disposed on the lid 118 and provides a structure for pivotally supporting the lid 118 on the zarf 122. The pivot portion 190 contains a cavity 192 and also includes a thumb detent 128. The cavity 192 is sized and positioned such that it encloses the arms 180 of the clevis 176 and allows free rotation of the lid 118 with respect to the zarf 122 when the lid 118 is moved between the closed and open positions. The pivot portion 190 also contains lid pin holes 194 through which the pin 184 passes, in a close-fitting engagement, to pivotally affix the lid 118 to the arms 180.

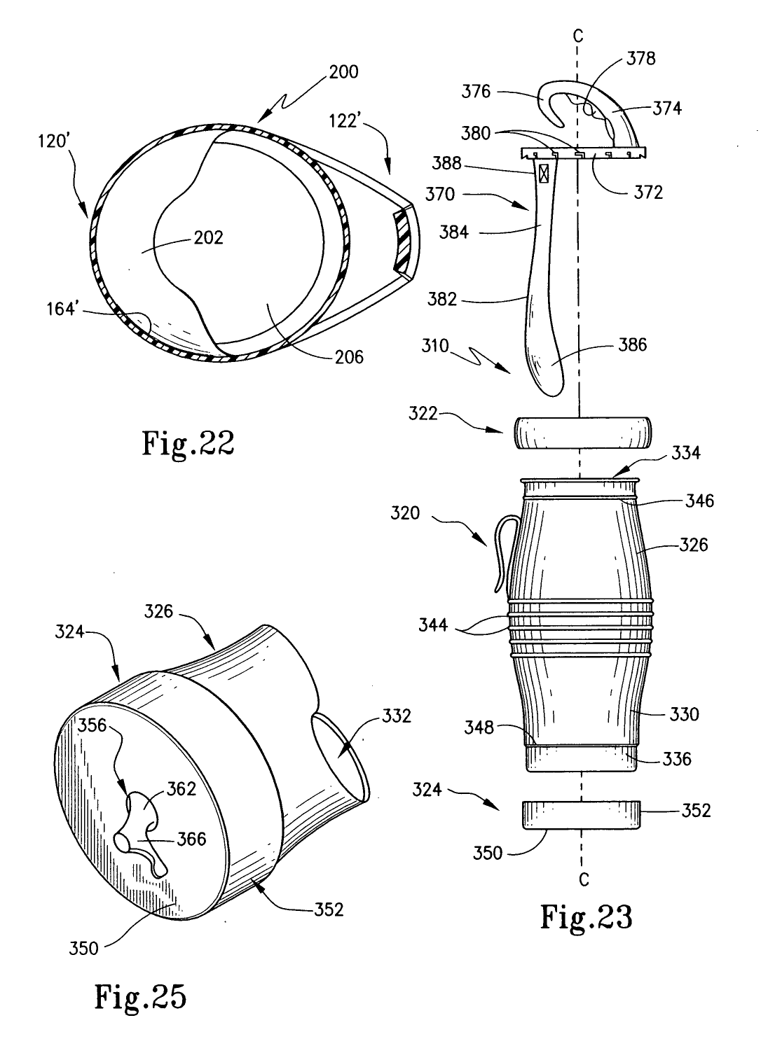

A third exemplary embodiment of the present invention, collection device 200, is shown in FIGS. 21 and 22. This embodiment is similar to collection device 110 of the second embodiment and includes a container body 120′ with an inner surface 164′, a collar insert 124′, a zarf 122′, a lid 118′ and may include a collection bag 116′. In this embodiment, the inner surface 164′ includes an affixed barrier in the form of a ledge 202 which serves to prevent waste already within the container from spilling out when new waste is collected. As seen in FIGS. 21 and 22, the ledge 202 is an arcuately-curved platform extending inwardly from the inner surface 164′ which separates the interior of the container body 120′ into a collection cavity 204 and a storage cavity 205 and defines a waste portal 206 connecting the two cavities. The ledge 202 is formed such that collected waste is deposited into the collection cavity 204 when scooped from a surface. Rotating the collection device 200 moves the waste through the portal 206 and into collection cavity 204. The ledge 202 functions to prevent that waste from moving back into the collection cavity 202 when the collection device 200 is rotated forwardly again to collect the next quantity of waste matter.

A fourth exemplary embodiment of the present invention is illustrated in FIGS. 23-31. The components of collection device 310 according to the fourth exemplary embodiment are introduced in FIG. 23. Here, it may be seen that collection device 310 includes a container 320 that is provided with a retaining collar 322 at one end and an end cap 324 at the opposite end. Container 320 receives and supports a scoop assembly 370 as described more thoroughly below.

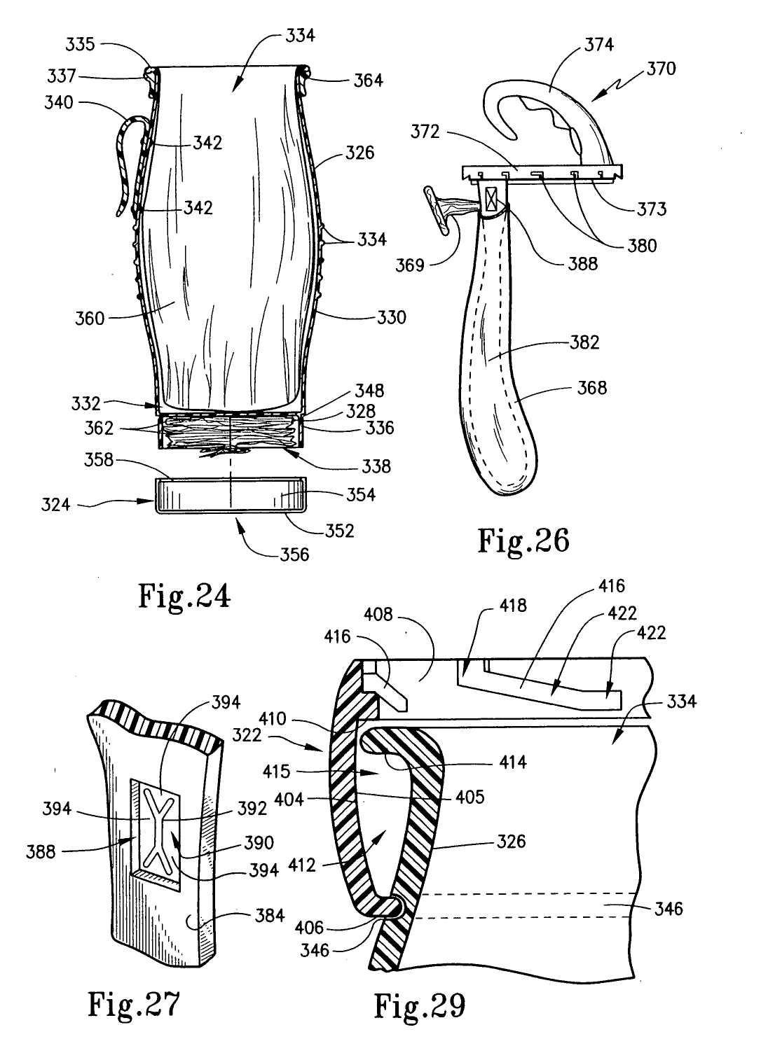

With reference to FIGS. 23-25, the construction of container 320 may be appreciated with greater understanding. Here, it may be seen that container 320 includes a container body 326 that has a bottom wall 328 and a surrounding sidewall 330 that defines an interior 332. Interior 332 is sized sufficiently so that the majority portion of a collection bag 360 may be placed therein through an open mouth 334 at an end of container body 326 opposite bottom wall 328. In this embodiment, also, a second surrounding sidewall 336 projects from bottom wall 328 oppositely of sidewall 330 so as to form an auxiliary bag compartment 338 that receives auxiliary collection bags 362 as shown in FIG. 24. Container body 326 has a clip 340 secured thereto, for example, by rivets 342 with clip 340 being of a typical type to secure objects to the belt of the wearer. It should be understood, however, that other mounting structures are entirely within the scope of this invention. In addition, if desired, container body can be provided with rubberized grips 344 to facilitate grasping by the hand of the user.

Container body 326 has a first circumferential groove 346 approximate to open mouth 334 in order to secure collar 322 thereto, in a manner described more thoroughly below. A second circumferential groove 348 is located proximately to sidewall 336 and, indeed, is formed in the plane of bottom wall 328. Groove 348 is used to secure end cap 324 to container body 326. Specifically, as is shown in FIG. 24, end cap 324 is formed by an end wall 350 and a surrounding sidewall 354 that has a central opening 356 formed therein. End cap 324 has an radially inwardly projecting lip 358 with this lip 358 being sized to engage groove 348 when end cap 324 is mounted on container body 326. To this end, the longitudinal extension of sidewalls 336 and 352 are of a corresponding length to allow this snap fit engagement and thereby enclose auxiliary bag compartment 338.

With reference to FIGS. 24 and 25, it may be seen that active collection bag 360 includes a margin 364 that extends outwardly of mouth 334 and is reversed curved along the upper portion of sidewall 330. Auxiliary storage bags 362, stored in compartment 338, are contained by means of end cap 324. However, as a result of access opening 356, a small portion 366 of a representative bag 364 may protrude outwardly of compartment 338 so that a user may simply pull an auxiliary bag out of the auxiliary bag compartment 338 without the need to remove end cap 324.

With reference now to FIGS. 26 and 27, it may be seen that scoop assembly 370 includes a disk shaped plate or lid 372 that is adapted to mount on and seal open mouth 334 of container body 326. An arcuate handle 374 projects generally in a longitudinal direction from lid 372 on one side thereof. Arcuate handle 374 includes a hooked end 376 to allow hanging of either scoop assembly 370 or the collection device 310 (when scoop assembly 370 is secured to container 320) from a convenient support, such as a support bar, prong, or the like. In addition, handle 374 may be provided with rubberized finger grip 378 to increase comfort to the users hand. Lid 372 includes a plurality of radially outwardly projecting tabs 80 that serve to secure scoop assembly 370 and container 320 together, as described below.

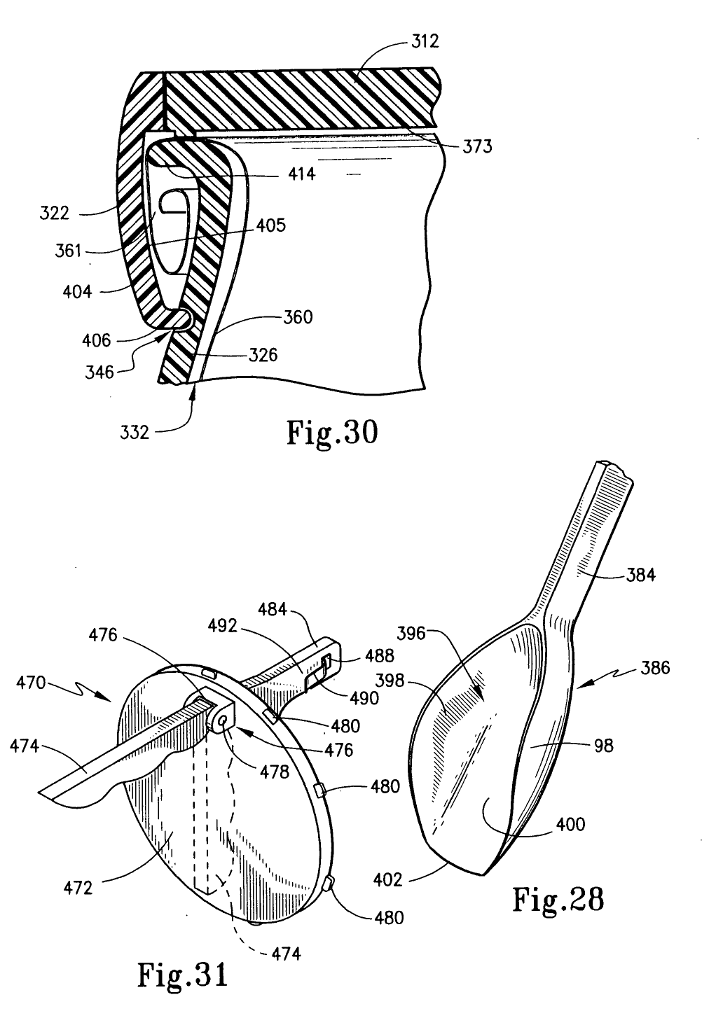

With reference now to FIGS. 23, 26 and 28, it may be seen that an elongated scoop 382 is supported by lid 372 on a side thereof opposite handle 374. Scoop 382 includes an elongated shank 384 that has its proximal end secured to lid 372 but terminates in a formed scooping head 386 at the distal end thereof. Scoop 382 projects generally longitudinally of collection device 310 and is generally parallel and opposite to central access “C”, as is shown in FIG. 23. Scooping head 386 is best shown in FIG. 28 where it may be seen that scooping head 386 includes a concavity 396. Concavity 396 is formed by arcuate sides 398 that project from shank 386 sides 398 longitudinally diverge from one another as they move away from shank 384 and are upwardly and outwardly flared from bottom 400 of scooping head 386. Bottom 400 terminates in a distal leading edge 402 that is generally transverse to the axis of shank 384. Concavity 396 opens toward axis “C” when scoop assembly 370 is received in container body 326.

Scoop 382 is provided with a bag retaining structure 388 at the proximal end of shank 384, with this bag restraining structure 388 best shown in FIG. 27. In this figure, it may be seen that shank3 84 has a recess 390 formed therein so as to form a generally reduced thickness. A generally x-shaped slot is formed in this portion of reduced thickness so as to create a plurality of wings 394. As noted below, shank 384 is preferably formed of a plastic material such that, when wings 394 are formed, they may slightly flex. With reference, now, to FIG. 26, it may be seen that scoop 382 may be received within a scoop protecting bag 368 with a mouth portion 369 inserted through x-shaped slot 392 to be trapped by the resiliency of wings 394 so that bag 368 is retained on scoop 382. Naturally, it is desirable that scoop protecting bag 368 be identical to collection bag 360 to avoid having two different sized bags for the use of the collection system according to the present invention.

The interaction of collar 322 with container body 326 and lid 372 of scoop assembly 370 may now be appreciated with more understanding with reference to FIGS. 29 and 30. In FIG. 29, it may be seen that retaining collar 322 is in the form of an annular ring having a longitudinally extending sidewall 404. Sidewall 404 terminates, at a lower end, in a inwardly projecting flange 406. A radially inwardly projecting ridge 408 is formed at another edge of sidewall 404 opposite flange 406 so as to define a shoulder 410. Collar 322 thus has an interior 412 so that it may receive the upper end portion of container body 326 in close fitted engagement. To this end, sidewall 404 is configured and dimensioned so that, when mounted on container body 326 as shown in FIG. 29, flange 406 will engage circumferential groove 346 to snap-fit collar 322 thereon. Moreover, as is shown in FIG. 29, the upper rim of container body 326 includes an outwardly projecting flange 414 that abuts the interior side 405 of sidewall 404 when collar 322 is in a mounted state. Flange 414 thus forms an exterior channel 415 to receive a mouth portion of an active bag.

Ridge 408 has a plurality of cam channels 416 that are equal in number and spacing to tabs 380. To this end, both tabs 380 and channels 416 are equal angularly spaced around the circumference, respectively, of lid 372 and ridge 408. Each of channels 416 includes and entryway 418 and a locking region 420 which are connected by means of an inclined region 422. Thus, lid 372 may be mounted to collar 322 by inserting a respective tab 380 in a respective entryway 418 and then twisting lid 372 in a clock-wise direction relative to collar 322 so that each respective tab 380 is drawn from entryway 418 along inclined region 422 to locking region 420.

The attachment of lid 372 and thus scoop assembly 370 to container body 326 and collar 322 is best illustrated in FIG. 30. In this figure, it may be seen that this action acts to secure an active bag 360 in operative position. Turning, then, to this FIG. 30, it may be seen that the assembly of collection device 310 may be accomplished by first inserting an active bag 360 in the interior 332 of container body 326 so that a margin portion 361 extends over flange 414. Collar 322 is then snap-locked onto the upper portion of container body 326 so that flange 406 engages groove 346 to secure collar 322 to container body 326. This acts to trap a portion of margin 361 between flange 414 and side 405 of sidewall 404 in channel 415. Scoop assembly 370 is then secured to collar 322 by means of tabs 380 and cam channels 416 in the manner described above. When this occurs, lid 372 is advanced so that a ridge 373 formed thereon contacts an upper surface of flange 414 to additionally trap the margin 361 bag 360 therebetween. Thus, bag 360 is double-sealed on one hand by the contact of ridge 373 with flange 144 and, on the other hand, by the contact of flange 414 with side 405. To remove scoop assembly 370 and thus scoop 382 for use, the user simply rotates lid 372 a small amount in the clock-wise direction so as to disengage lid 372 from collar 322.

The user may then use scooping head 386, protected by bag 368, to scoop pet refuse into container 320 that, in turn, is protected by collection bag 360. When finished, the user simply reattaches scoop assembly 370 to container 320 and conveys the reference to a desired disposal location. To dispose of the refuse, the user again detaches scoop assembly 370 and removes mouth portion 369 of bag 368 from bag retaining structure 380 so that bag 368 may be deposited in the side of bag 360. Collar 322 is then removed so that bag 360 along with its contents can be removed from container body 326. The open mouth of bag 360 is then closed in any convenient manner, such as a wire tie, knotted or otherwise and bag 360 containing the refuse may be deposited in any convenient disposal receptacle.

Collar 322, end cap 324, container body 326 and scoop assembly 370 are each constructed of a suitable material such as plastic or metal. In particular, these pieces can be made by injection molding of a suitable plastic, such as polyethylene, polypropylene and the like. Lid 372, handle 374 and scoop 82 of scoop assembly 370 can be an integral one piece molding, if desired. However, the fabrication technique is not to be deemed limiting on the scoop of this invention.

As should be understood, the modifications of this present invention may be undertaken without departing from the scope. For example, FIG. 31 shows an alternative handle structure for a scoop assembly 470. Here, scoop assembly 470 is shown to have a disk-shaped lid 472 that is provided with the plurality of locking tabs 480 that are the same as tabs 380 described above. Scoop assembly 470 includes a scoop that includes a shank 484 that extends generally longitudinally. In FIG. 31, shank 484 is provided with an alternative bag retaining structure 488 in the form of a hook 490 including a piercing point 492 so that a mouth portion, such as mouth portion 369, of a scoop protecting bag may simply be secured to shank 484 by piercing a margin of the bag to retain it on the scoop and shank.

Also, as is shown in FIG. 31, an alternative handle structure is shown. Here, handle 474 is pivotally secured between clevis supports 476 that are at an opposed, spaced apart relation to one another. Handle 470 pivots on axle 478 between an active position shown in FIG. 31 and a passive position shown in phantom in FIG. 31. In this embodiment, handle 474 is generally aligned with shank 384 and, with the pivotal arrangement, it should be appreciated that the concavity of the scoop, as concavity 296 with respect to the embodiment described above, opens radially inwardly toward the central longitudinal axis. Since handle 474 is prevented from pivoting past a generally perpendicular orientation with respect to lid 472, the scoop may be used without handle 474 tending to fold upon itself.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

We claim:

1. A pet refuse collection device adapted to be used by a person to retrieve and store pet refuse for subsequent disposal, comprising:
(A) a container body having an open interior and including a base portion and a surrounding sidewall portion extending from said base, said sidewall portion having an upper rim defining an opening into the interior of said container body;
(B) a lid member adapted to be moved between an open position to permit access to the interior of said container body through the opening and a closed position wherein said lid encloses the interior; and
(C) a scoop member secured to one of said container body and said lid member and oriented such that, when said lid member is moved into the closed position, said scoop member is enclosed by said container body and said lid member.

2. A pet refuse collection device according to claim 1 wherein said scoop member is secured to said container body at a location proximate to the opening.

3. A pet refuse collection device according to claim 2 wherein said lid is a dome-like shell that fits over the scoop member when in the closed position.

4. A pet refuse collection device according to claim 3 wherein said container body and said lid are formed such that they define and egg-shaped configuration when said lid is in the closed position.

5. A pet refuse collection device according to claim 3 wherein said lid is pivotally secured to said container body.

6. A pet refuse collection device according to claim 2 wherein said scoop member is formed as a tongue-like extension of said sidewall at the rim thereof.

7. A pet refuse collection device according to claim 6 including a pair of flanges extending from said rim on either side of said scoop member, said flanges and said scoop member having an exterior channel formed therein and extending at least partially around said container body proximate to said rim, said channel adapted to engage a mouth of a flexible bag inserted into the interior of said container body.

8. A pet refuse collection device according to claim 1 wherein said scoop member includes an elongated shaft secured at a first end to said lid and that has a scoop portion located at a second end opposite said lid.

9. A pet refuse collection device according to claim 8 including a handle secured to said lid on a side thereof opposite said shaft.

10. A pet refuse collection device according to claim 9 wherein said handle is pivotally secured to said lid.

11. A pet refuse collection device according to claim 1 wherein said base is flattened whereby said container body may be set is a stable manner on a flat support surface.

12. A pet refuse collection device according to claim 1 including a handle secured to said container body.

13. A pet refuse collection device according to claim 12 wherein said handle is formed integrally with said container body.

14. A pet refuse collection device according to claim 1 including a clip element secured to said container body and adapted to mount said container body to an article of clothing worn by the person in order to facilitate transport of the pet refuse collection device.

15. A pet refuse collection device according to claim 1 wherein said container body has an exterior channel formed therein and extending at least partially around said container body proximate to said rim, said channel adapted to engage a mouth of a flexible bag inserted into the interior of said container body.

16. A pet refuse collection device according to claim 15 including a collar releasably securable to said container body to trap the mouth of a flexible bag in the channel.

17. A pet refuse collection device according to claim 15 including an upstanding flange located proximately to said rim and provided with a notch formed therein, the notch adapted to engage a gathered portion of the mouth of a flexible bag inserted into the interior of said container body.

18. A pet refuse collection device according to claim 1 wherein said lid is pivotally secured to said container body, said lid being spring-biased toward the open position.

19. A pet refuse collection device according to claim 18 including a latch movable between an engage state wherein it retains said lid in the closed position and a disengage state wherein it permits said lid to move into the open position.

20. A pet refuse collection device according to claim 19 wherein said latch is biased into the engage state.

21. A pet refuse collection device according to claim 20 wherein said latch includes a ramp portion, said lid including a finger terminating in an edge positioned to engage said ramp portion of said latch when said lid moves from the open positioin to a closed position thereby to move said latch from the engage state to the disengage state.

22. A pet refuse collection device according to claim 1 wherein said container body includes a compartment formed separate from the interior and adapted to store extra bags for placement in the interior of said container.

23. A pet refuse collection device according to claim 1 wherein said sidewall includes a step profile formed therein thereby to form an external shoulder operative to engage an edge of said lid to provide a substantial seal when said lid is in the closed position, said step profile forming at least one internal step operative to assist in retaining refuse placed in the interior of said container body against spillage.

24. A pet refuse collection system adapted to be used by a person to retrieve and store pet refuse for subsequent disposal, comprising:
(A) a container body having an open interior and including a base portion and a surrounding sidewall portion extending from said base, said sidewall portion having an upper rim defining an opening into the interior of said container body;
(B) a lid member adapted to be moved between an open position to permit access to the interior of said container body through the opening and a closed position wherein said lid encloses the interior;
(C) a scoop member secured to one of said container body and said lid member and oriented such that, when said lid member is secured to said container body in the closed position, said scoop member is enclosed by said container body and said lid member; and
(D) a flexible bag lining the interior of said container and having a mouth releasably secured proximately to the rim of said sidewall.

25. A pet refuse collection system according to claim 24 wherein said scoop member is formed as a tongue-like extension of said sidewall at the rim thereof.

26. A pet refuse collection system according to claim 25 including a pair of flanges extending from said rim on either side of said scoop member, said flanges and said scoop member having an exterior channel formed therein and extending at least partially around said container body proximate to said rim, said channel adapted to engage the mouth of said flexible bag.

27. A pet refuse collection system according to claim 24 wherein said lid is pivotally secured to said container body.

28. A pet refuse collection system according to claim 24 wherein said scoop member includes an elongated shaft secured at a first end to said lid and that has a scoop portion located at a second end opposite said lid.

29. A pet refuse collection system according to claim 28 including a handle secured to said lid on a side thereof opposite said shaft.

30. A pet refuse collection system according to claim 24 including a handle secured to said container body.

31. A pet refuse collection system according to claim 24 wherein said container body has an exterior channel formed therein and extending at least partially around said container body proximate to said rim, said channel adapted to engage the mouth of said bag.

32. A pet refuse collection system according to claim 31 including a collar releasably securable to said container body to trap the mouth of a flexible bag in the channel.

33. A pet refuse collection system according to claim 31 including an upstanding flange located proximately to said rim and provided with a notch formed therein, the notch adapted to engage a gathered portion of the mouth of a flexible bag inserted into the interior of said container body.

34. A pet refuse collection system according to claim 24 wherein said lid is pivotally secured to said container body, said lid being spring-biased toward the open position.

35. A pet refuse collection system according to claim 34 including a latch movable between an engage state wherein it retains said lid in the closed position and a disengage state wherein it permits said lid to move into the open position.

36. A pet refuse collection system according to claim 35 wherein said latch is biased into the engage state.

37. A pet refuse collection system according to claim 36 wherein said latch includes a ramp portion, said lid including a finger terminating in an edge positioned to engage said ramp portion of said latch when said lid moves from the open position to a closed position thereby to move said latch from the engage state to the disengage state.

38. A pet refuse collection device adapted to be used by a person to retrieve and store pet refuse for subsequent disposal, comprising:
(A) a container body having an open interior and including a base portion and a surrounding sidewall portion extending from said base, said sidewall portion having an upper rim defining an opening into the interior of said container body;
(B) a lid member pivotally secured to said container body and adapted to be moved between an open position to permit access to the interior of said container body through the opening and a closed position wherein said lid encloses the interior, said lid member being spring-biased toward the open position;
(C) a scoop member secured to said container body and formed as a tongue-like extension of said sidewall at the rim thereof, said scoop member being oriented such that, when said lid member is moved into the closed position, said scoop member is enclosed by said container body and said lid member; and
(D) a latch movable between an engage state wherein it retains said lid in the closed position and a disengage state wherein it permits said lid to move into the open position.

39. A pet refuse collection device adapted to be used by a person to retrieve and store pet refuse for subsequent disposal, comprising:
(A) a container body having an open interior and including a base portion and a surrounding sidewall portion extending from said base, said sidewall portion having an upper rim defining an opening into the interior of said container body;
(B) a lid member adapted to be moved between an open position to permit access to the interior of said container body through the opening and a closed position wherein said lid encloses the interior; and
(C) scoop means associated with one of said container body and said lid member and adapted to be manipulated by the person in order to retrieve pet refuse and introduce said pet refuse into the interior of said container body.

40. A pet refuse collection system adapted to be used by a person to retrieve and store pet refuse for subsequent disposal, comprising:
(A) a container body having an open interior and including a base portion and a surrounding sidewall portion extending from said base, said sidewall portion having an upper rim defining an opening into the interior of said container body;
(B) a lid member adapted to be moved between an open position to permit access to the interior of said container body through the opening and a closed position wherein said lid encloses the interior;
(C) scoop means associated with one of said container body and said lid member and adapted to be manipulated by the person in order to retrieve pet refuse and introduce said pet refuse into the interior of said container body; and
(D) a flexible bag lining the interior of said container and having a mouth releasably secured proximately to the rim of said sidewall.
